(19) United States
(12) Patent Application Publication
(10) Pub. No.: US 2026/0158769 A1
(43) Pub. Date: Jun. 11, 2026

(54) PRINTED PACKAGING MATERIAL WITH IMPROVED RECYCLABILITY AND METHOD FOR ITS PRODUCTION

(71) Applicant: Constantia Pirk GmbH & Co. KG, Pirk (DE)

(72) Inventors: Inna DEWALD, Weiden (DE); Thomas KESMARSZKY, Weiherhammer (DE); Stefan BÜTTNER, Neumarkt (DE); Achim GREFENSTEIN, Altrip (DE)

(21) Appl. No.: 18/707,470

(22) PCT Filed: Nov. 3, 2022
(86) PCT No.: PCT/EP2022/080665

§ 371 Date: May 3, 2024

(30) Foreign Application Priority Data
Nov. 3, 2021 (DE) 10 2021 128 655.7
Nov. 3, 2021 (DE) 20 2021 106 227.4

(51) Int. Cl. B32B 27/08; B29B 17/00; B29B 17/04; B32B 7/12

(52) U.S. Cl. CPC B32B 27/08; B29B 17/0412; B32B 7/12; B29B 2017/0015; B32B 2250/02; B32B 2250/24; B32B 2255/10; B32B 2305/70; B32B 2307/308; B32B 2439/00

(57) ABSTRACT

Disclosed is a recyclable plastic-containing packaging material formed of a carrier material which has at least two plastic films laminated with an adhesive. The films have at least 70% by weight of a single type of monomer and/or polymer, and an optically perceptible element formed by a printing ink. The printing ink and/or the adhesive is thermally stable and has a weight loss of less than 20% when exposed to a temperature in the range of ≥30° C. and ≤320° C. Also disclosed is a method for predicting the recyclability of a plastic-containing packaging material having a printing ink and/or an adhesive.

The present invention relates to a printed and/or adhesive-containing packaging material. Furthermore, the invention relates to a package comprising such a packaging material, the recyclate resulting from the recycling process of this packaging material, and to a method for producing such a packaging material. Furthermore, the present invention relates to a method for predicting the recyclability of such a packaging material.

Various plastic materials and composites are known from the state of the art for packaging purposes, for example for packaging foodstuffs. In order to meet the requirements regarding the protection of the packaged goods, these plastic packages often include barrier layers. In order to provide a barrier for several substances or substance classes, composites and/or laminates of different materials are often used. The packaging is often printed in order to identify the packaged goods and/or assign them to a specific company and/or manufacturer.

Such packaging materials often comprise several layers, not all of which necessarily have to be made of plastic. For example, packaging is known to contain layers of metal and/or paper.

The recyclability of packaging has gained enormously in importance in recent years. There is an increasing demand for packaging that offers sufficient safety for the goods to be packaged, but can also be recycled as completely as possible.

While a high proportion of cellulose fibers from paper and metals are already recycled and can be used to manufacture high-quality products, the recyclability of plastics is still limited and the material obtained during recycling can often only be thermally recycled due to impurities or further processed into low-value products with low requirements for the purity of the materials used.

In order to increase the recyclability of plastics, attempts have been made in the past to produce packaging materials from a single type of plastic wherever possible. However, in order to meet the requirements in terms of mechanical strength, barrier properties, printability and/or processability, laminates are often used in which different polymers of a single monomer type and its related comonomers (e.g. alpha-olefins for the synthesis of LLDPE) are used. For example, starting from ethylene as the only monomer, polymers can be obtained which can be assigned to the groups HDPE (high density polyethylene), LDPE (low density polyethylene), LLDPE (linear low density polyethylene), PE-HMW (high molecular weight polyethylene), PE-UHMW (ultra high molecular weight HDPE) and PE-X (post-crosslinked PE). Furthermore, any type of polyethylene is conceivable as a polyolefin material and is preferred for some embodiments. In particular, ethylene copolymers selected from a group comprising ethylene-vinyl acetate copolymer (EVA), methacrylic acid ethyl ester (EMA), ethylene/acrylic acid copolymer (EAA) and ethylene-butyl acrylate copolymer (EBA) are preferred. Preferably, these copolymers have ethylene in a weight and/or particle fraction ≥70%.

Starting from propylene, the additional methyl group compared to ethylene results in a plurality of additional variation possibilities. For example, the properties of a polypropylene can be differentiated into isotactic polypropylene (iPP), syndiotactic polypropylene (sPP) and atactic polypropylene (aPP) by the arrangement of the additional group within a chain. Furthermore, any combination of polypropylene with ethylene as a comonomer is conceivable as a polyolefin material and is preferred for some applications. Preferably, a polypropylene copolymer is selected from a group comprising polypropylene random copolymer with ethylene as comonomer and a polypropylene-ethylene block copolymer. Preferably, these copolymers have propylene in a weight proportion ≥70%.

Foams based on propylene (polypropylene foam (EPP)) are also known. Mechanical (post) treatment of polypropylene (films) can also change the properties due to a preferred direction of the polymer chains. For example, unstretched polypropylene films (CPP) and unstretched polypropylene films (OPP and BOPP) are known. In the case of oriented polypropylene films, a distinction can be made between polypropylene films oriented in one direction (OPP (oriented polypropylene)) and polypropylene films oriented in two directions (BOPP (biaxially oriented polypropylene)).

However, it has been shown that even packaging materials that contain a single type of plastic as the base material only exceptionally provide raw materials that meet the quality requirements for the manufacture of high-quality plastic products when recycled. Customers therefore have major reservations about plastic recyclates and the potential uses for plastic recyclates remain limited.

There is therefore a need for plastic products, especially plastic packaging, that are easier to recycle and whose recyclate contains fewer impurities than the plastic products currently on the market, especially plastic packaging. There is also a need to be able to make predictions about the recyclability of plastic products if they contain additional ingredients in addition to the plastic.

This object is solved by the subject matters of the independent patent claims. One solution to the above problem lies in a recyclable, plastic-containing packaging material comprising a carrier material which comprises at least two plastic films laminated with an adhesive. These films comprise at least 70 percent by weight of a single type of monomer and/or polymer. Furthermore, such a packaging material comprises an optically perceptible element formed by a printing ink and is characterized in particular by the fact that the printing ink and/or the adhesive is thermally stable and exhibits a weight loss of less than 20% when exposed to a temperature in the range of ≥30° C., preferably ≥100° C., more preferably ≥125° C., further preferably ≥130° C., particularly preferably ≥140° C. and very particularly preferably ≥150° C., and ≤320° C., preferably ≤300° C. This weight loss can be caused, for example, by decomposition of the printing ink or adhesive. It is conceivable that decomposition products—such as H₂O, CO, CO₂, NOx—pass into the gas phase and thus lead to a reduction in the weight of the sample. Preferably, the adhesive is a PU adhesive. Alternatively or additionally, EVA adhesives could also be used and are preferred for some applications.

In a preferred embodiment, at least one of the films comprises at least one additive, which is preferably selected from a group comprising catalyst, plasticizer, dye, pigment, anti-blocking agent, bactericide, fungicide, sterilizing agent, light stabilizer, in particular UV absorber and/or Hindered Amine Light Stabilizers (HALS), mold release agent, lubricant, flame retardant, antioxidant, thermostabilizer, crosslinking agent and/or HALS, light stabilizer, in particular UV absorber and/or hindered amine light stabilizer (HALS), demoulding agent, lubricant, flame retardant, antioxidant, thermostabilizer, crosslinking additive, emulsifier, filler and antistatic agent as well as combinations thereof.

The values given above for weight loss on exposure to temperature preferably refer to a dried or (partially) cured sample of the respective substance and/or mixture. For example, it is often common to apply printing inks to a substrate in liquid form. For this purpose, dyes are dissolved in a liquid or are present as an emulsion or suspension in a liquid. Adhesives (also referred to as adhesives for short) also often set and/or cure, wherein the consistency of the adhesive can change. This change in consistency can be associated with the outgassing of substances and/or the evaporation of liquids. Analogous reactions can also occur with other additives, which in a preferred embodiment can also be contained in a packaging material as described above.

Preferably, the plastic of the plastic films comprises at least 70 percent by weight, preferably more than 90 percent by weight, particularly preferably more than 95 percent by weight, of polymerization products of propylene or ethylene or butadiene or ethenylbenzene or a propene acid ester or butane or hexane or octane. In particular, it is preferred that in each case only one of the above-mentioned monomers is used for polymerization to the plastic and therefore the plastic is a reaction product of a single monomer and/or a single type of polymer. However, monomers often contain impurities in small quantities which are nevertheless suitable for the production of high-quality plastics. Such impurities are also tolerable within the scope of the present invention. The weight percentage stated above preferably refers exclusively to the proportion of substances that can be polymerized under the selected polymerization conditions. Non-polymerizable substances such as a catalyst, any solvent present, a (radical) starter, a quencher and other additives influencing the polymerization are not taken into account when calculating the above-mentioned percentage by weight.

It has proven to be particularly disadvantageous if the decomposition of the printing ink and/or the adhesive and/or the additive produces large quantities of gaseous decomposition products. These can cause (gas) bubbles to form in the plastic or recyclate during recycling. These are often difficult to remove and can be detrimental during further processing of the recyclate. Therefore, a packaging material is preferred in which the printing ink and/or the adhesive and/or the additive forms ≤15 percent by weight, preferably ≤10 percent by weight, more preferably ≤5 percent by weight, particularly preferably ≤3 percent by weight, and most preferably no gaseous decomposition products when exposed to temperature. Like all other percentages in the context of the present invention, unless otherwise stated, these figures refer to the percentage by weight based on the total weight of a sample of the printing ink and/or the adhesive and/or the additive (or a mixture thereof) before the temperature is applied.

Preferably, a packaging material in which the printing ink and/or the adhesive and/or the additive exhibits a weight loss as described above when exposed to a temperature in the range of ≥30° C. and ≤320° C., preferably ≥200° C. and ≤310° C., further preferably ≥250° C. and ≤300° C. and in particular preferably in the range of ≥150° C. and ≤320° C. In addition or alternatively, a packaging material is preferred in which the printing ink and/or the adhesive and/or the additive has a weight loss of less than 15%, preferably ≤10%, further preferably ≤5%, in particular preferably ≤3%, when exposed to temperature, preferably at a temperature in one of the above-mentioned ranges (optionally also at one of the lower temperature limits defined above). An overview of exemplary weight losses of various printing inks when exposed to temperature can be found in Table 1 below.

TABLE 1
Examples of printing inks applied
in gravure or flexographic printing

| | Temperature range |
|---|---|
| | 30° C. to 260° C. |
| Printing inks | Amount of fission products in % |
| Cellulose nitrate | 28.5-29.6 |
| Cellulose nitrate + polyurethane | 18.6 |
| Polyvinyl chloride | 2.8-6.9 |
| Polyvinyl butyral | 4.7 |
| Polyurethane | 1.7 |

The weight losses of the respective printing ink due to the formation of cleavage products shown in Table 1 were determined by thermogravimetric analysis of a respective sample of the printing ink to be analyzed. Each measurement was carried out over a temperature range including at least the temperature range ≥30° C. and ≤320° C., preferably ≥30° C. and ≤260° C. The values shown in Table 1 represent an extract from a thermogravimetric analysis carried out in a temperature range of 30-900° C. However, only the volume loss of the printing inks or laminating adhesives occurring in the temperature range ≥30° C. and ≤260° C. is shown. The weight loss is determined by the mass difference of the sample at 30° C. and 260° C. The course of the (temperature-dependent weight loss) curve determined during the thermogravimetric analysis of various printing inks can provide information on the temperature range in which the decomposition of the printing ink leads to a particularly strong weight loss. Even if there is a weight loss of ≤20% by weight for the printing ink and/or adhesive contained in the packaging material according to the invention when exposed to a temperature in the range of ≥30° C. and ≤320° C., a range of ≥130 to ≤260° C. nevertheless forms a range for many of these printing inks and/or laminating adhesives in which a large (negative) gradient occurs in the thermogravimetric analysis.

It has been shown that in particular printing inks based on polyurethane, polyvinyl chloride, polyvinyl acetal, in particular polyvinyl butyral or combinations thereof fulfill this requirement. Therefore, a packaging material is preferred which has a printing ink which has a component selected from a group comprising polyurethane, polyvinyl chloride, polyvinyl acetal, in particular polyvinyl butyral.

As can also be seen from Table 1, not all printing inks meet the requirements of the present invention. Printing inks that are based on cellulose nitrate or contain it in large quantities, for example, show an amount of cleavage products that is well outside the acceptable range at over 18%, in some cases even over 28% to almost 30%. Such printing inks are unsuitable in the context of the present invention and can be understood as non-thermally resistant printing inks.

Preferably, the packaging material is a packaging film and/or a packaging container. Both flexible films and containers of a predetermined shape are used for packaging purposes in a variety of forms. Combinations of films and dimensionally stable containers are also known, for example in the case of plastic salad cups that are sealed with a film of the same plastic.

The plastic can be part of a packaging composite, for example a paper-plastic composite. Preferably, it is a film composite. The individual (material) layers can preferably be separated from each other (non-destructively) so that each material/layer can be fed into the respective recycling process, preferably by type.

In a preferred embodiment, the printing ink is a color, in particular an ink. The printing ink can be applied to the packaging material by gravure printing, flexographic printing, UV flexographic printing, offset printing or digital printing, for example. Preferably, the applied print is covered by a protective layer.

Preferably, the plastic is selected from a group comprising HDPE (high density polyethylene), LDPE (low density polyethylene), LLDPE (linear low density polyethylene), PE-HMW (high molecular weight polyethylene), PE-UHMW (ultra high molecular weight HDPE), ethylene copolymers, preferably (in each case independently of one another) ethylene-vinyl acetate copolymer (EVA), methacrylic acid ethyl ester (EMA), ethylene/acrylic acid copolymer (EAA) and ethylene-butyl acrylate copolymer (EBA) or mixtures thereof, isotactic polypropylene (iPP), syndiotactic polypropylene (sPP) and atactic polypropylene (aPP), polypropylene foam (EPP), unstretched polypropylene film (CPP), (unidirectional or bidirectional) stretched polypropylene films (OPP and BOPP) or mixtures thereof, combinations of polypropylene with ethylene as comonomer, preferably polypropylene copolymer, preferably polypropylene random copolymer with ethylene as comonomer, preferably polypropylene-ethylene block copolymer.

Furthermore, the invention is directed to a plastic recyclate comprising a packaging material as described above. Preferably, this plastic recyclate comprises a packaging material as described above in a weight proportion of ≥25%, preferably ≥70%, more preferably ≥75%, in particular preferably ≥90%.

As described above with regard to the packaging material, this is particularly easy to recycle. It has been shown that mixtures with other plastic materials (preferably based on the same type of monomer and/or polymer) also represent a higher quality recyclate compared to known recyclates. This can be explained in particular by the fact that less decomposition products are produced during the thermal treatment of (preferably sorted, in particular preferably unmixed) plastic waste to form plastic or recyclate granulates. The low proportion of decomposition products and, in particular, gaseous decomposition products means that fewer low-molecular impurities are formed in the recyclate and, in particular, fewer gas inclusions are formed in the granulate. These can lead to high mechanical stresses on the material, particularly at the high pressures and pressure differences that occur during the extrusion of plastics, which can have a detrimental effect on the chemical and/or physical properties of the polymer.

In particular, it is preferred that the plastic recyclate is a granulate. Granulates have proven to be particularly suitable in the plastics processing industry, as they are easy to handle and, in particular, easy to extrude.

Preferably, the granulate has an average particle size (d₅₀ sieve analysis) in the range from ≥0.5 mm to ≤25 mm, preferably ≥0.75 mm to ≤20 mm, more preferably ≥1 mm to ≤10 mm and particularly preferably ≥0.3 mm to ≤6 mm. Granules of this medium particle size are particularly easy to handle, do not tend to form dust and can still be easily and homogeneously shaped in an extruder.

A plastic recyclate as described above can be obtained particularly advantageously by a method comprising the following steps:
a) providing plastic waste comprising a packaging material as described above, preferably in a proportion by weight of ≥25%, preferably ≥70%, further preferably ≥75%, in particular preferably ≥90%;
b) cleaning the plastic waste;
c) sorting and/or shredding and/or mixing the plastic waste, if necessary;
d) feeding the plastic waste into an extruder and producing an extrudate from the plastic waste; and
e) crushing the extrudate into granules.

This method makes it particularly easy to recycle a packaging material as described above. The resulting granulate has a high degree of purity and the physical and/or chemical properties largely correspond to those of plastics that can be obtained from primary raw materials.

It was found that even comparatively small quantities of the packaging material described above are sufficient to positively influence the properties of the recyclate. However, a high proportion of the packaging material as described above is preferred, as this can reduce the amount of decomposition products produced during the thermal treatment of the plastic mixture. In particular, the amount of gas produced during thermal treatment can preferably be reduced.

The formation of gases is particularly detrimental during the extrusion of plastics into plastic strands, which can then be further processed into pellets. Usually, shredded plastic waste is fed into an extruder, where it is conveyed towards a nozzle at an increased temperature and pressure.

At this temperature and pressure, the plastic particles soften and become flowable. However, the decomposition products produced in the process can have a negative impact on flowability. For example, they can have a different softening point than the plastic and thus be present as solids in the melt and have a negative effect on viscosity. Gaseous decomposition products have the additional problem that their behavior is also dependent on the prevailing pressure. As the pressure conditions change several times during the extrusion of plastics, there is a risk of gas bubbles forming in the melt. These can also have a detrimental effect on the viscosity of the melt. Furthermore, they have the disadvantage that the gas trapped in these bubbles-if the pressure conditions change abruptly after leaving the extruder through its die-escapes abruptly from the extruded strand and thus cracks the extrudate. The formation of a homogeneous extrudate and the formation of pellets of a defined particle size is therefore impossible.

In order to avoid contamination, which can lead to the disadvantages described above, cleaning of the plastic waste is provided for in step b). When this step is carried out has no significant influence on the method, which is why the sequence of steps can essentially be freely selected. For example, it can be adapted to the conditions on site. However, it is essential that cleaning takes place before feeding into the extruder.

Step c) can also be carried out depending on the prevailing conditions. However, steps such as sorting, shredding and/or mixing the plastic waste may not be necessary. If, for example, a pure mixture of plastic waste is already available, further sorting can be omitted. The size of the packaging waste that can be used for further processing can also depend on the respective conditions. If the extruder is suitable for treating large packaging waste, further shredding may not be necessary. Mixing different plastic waste can also be advantageous or not, depending on the plastic waste available and/or the requirements for the pellets to be produced. Preferably, only packaging waste obtained from a single type of monomer and/or polymer is mixed, wherein—as described above—minor impurities may be tolerable.

The present invention is further directed to a method for predicting the recyclability of a plastic material comprising a printing ink and/or an adhesive and/or an additive. This method is characterized by the steps:
provide a sample of the ink and/or adhesive and/or additive;
performing a thermogravimetric analysis of the sample, wherein the thermogravimetric analysis includes at least one measurement of the mass changes in a temperature range of ≥30° C. to ≤320° C.;
set a critical temperature value in this temperature range;
determine the mass loss of the sample at the critical temperature;
classify the recyclability of the ink and/or adhesive and/or additive based on the mass loss of the sample at the critical temperature.

It has been shown that this method can provide a good prediction of the recyclability of a plastic equipped with the substances subjected to thermogravimetric analysis.

Preferably, the recyclability is classified on the basis of the mass loss of the sample, wherein a weight loss limit value of less than 20%, preferably ≤15%, preferably ≤10%, further preferably ≤5%, in particular preferably ≤3% is set for good recyclability.

Preferably, the printing ink and/or the adhesive and/or the additive is dried and/or cured before the thermogravimetric analysis is carried out.

For printing inks, it is particularly preferred that drying is carried out at a temperature ≥20° C. and ≤100° C., preferably ≥30° C. and ≤50° C., particularly preferably at 40° C.±3° C. Additionally or alternatively, it is preferred that the drying is carried out over a period of between ≥2 days and ≤14 days, preferably ≥3 days and ≤10 days, further preferably between ≥4 days and ≤7 days, in particular preferably 5 days±12 hours.

A temperature range between ≥50° C. and ≤150° C., preferably 80° C.-120° C., particularly preferably ≥90° C.-110° C., has proven to be suitable for drying or curing an adhesive. In addition or alternatively, the drying and/or curing period is preferably around 5 days (possibly ±24 hours). Typically, after this period, the isocyanate and/or solvent content is ≤5% by weight. Preferably, however, at least one of these two values is checked. If one or both of these values exceeds a specified limit value, which is preferably set at ≤5 percent by weight, the drying and/or curing period at the above-mentioned temperature is preferably extended. The additional drying and/or curing period is preferably between ≥1 day and ≤5 days, preferably ≥2 days and ≤4 days, in particular preferably 3 days±12 hours. The solvent content is preferably tested by head-space GC and—independently of this—the isocyanate content is preferably tested by ATR-FTIR analysis.

Drying and/or curing preferably takes place on a solid carrier. In particular, it is preferred that the solid carrier has a high thermal conductivity. In particular, it is preferred that the carrier comprises a metal or is made of metal. In particular, a carrier made of aluminum has been shown to be advantageous, since such a carrier is also resistant to corrosion by a plurality of materials.

Preferably, a sample of less than 500 mg is used for thermogravimetric analysis. Small sample quantities have proven to be advantageous, as these react particularly quickly to temperature changes and the applied temperature can quickly be homogeneous throughout the sample. Preferably, a sample quantity of ≤200 mg, preferably ≤100 mg, further preferably ≤50 mg, more preferably ≤20 mg, and particularly preferably of 10 mg, possibly ±5 mg, is used for the thermogravimetric analysis.

The drying and/or curing of the sample means that in a comparatively short time the ink and/or adhesive and/or additive is present in a form that is also present in the packaging material when it is sent for recycling. The predictions of recyclability are therefore particularly reliable.

In a preferred variant, it is provided that in the method the thermogravimetric analysis is carried out with a temperature increase of ≥10° C./min and ≤100° C./min, preferably ≥20° C./min and ≤50° C./min, further preferably ≥25° C./min and ≤40° C./min, in particular preferably at 30° C./min±3° C./min. It has been shown that at this temperature increase, the decomposition of the commonly used materials takes place in a manageable time and the sample still has sufficient time to homogeneously reach the decomposition temperature of the respective substance. The reproducibility of the results can thus be increased.

In a preferred method variant, the thermogravimetric analysis is followed by an analysis of the resulting decomposition products. In particular, it is preferred that the decomposition products are analyzed by gas chromatography. Preferably, the gas chromatographic analysis is carried out at a trigger temperature of 260° C. Preferably, the trigger temperature is adapted to the melting temperature of the plastic (for example the PE melting temperature) during regranulation.

1-15. (canceled)

16. A recyclable, plastic-containing packaging material, comprising
a carrier material comprising at least two plastic films laminated with an adhesive, wherein these films comprise at least 70 percent by weight of a single type of monomer and/or polymer, and
an optically perceptible element formed by a printing ink,
wherein
the printing ink and/or the adhesive is thermally stable and exhibits a weight loss of less than 20% when subjected to a temperature in the range of ≤30° C. and ≤320° C.

17. The packaging material according to claim 16,
wherein
the weight percent of the plastic of the plastic films is selected from the group consisting of at least 70 percent by weight, more than 90 percent by weight, and more than 95 percent by weight, of polymerization products of propylene or ethylene or butadiene or butane or hexane or octane or ethenylbenzene or a propanoic acid ester.

18. The packaging material according to claim 16, wherein
the printing ink and/or the adhesive is thermally stable and does not form any gaseous decomposition products when exposed to the temperature, and exhibit a weight loss in an amount selected from the group consisting of ≤15 percent by weight, ≤10 percent by weight, ≤5 percent by weight, and ≤3 percent by weight, and no gaseous decomposition products.

19. The packaging material according to claim 16, wherein the packaging material has a printing ink comprising a component selected from the group consisting of polyurethane, polyvinyl chloride, polyvinyl acetal, and polyvinyl butyral, and combinations thereof.

20. The packaging material according to claim 16, wherein
the plastic is selected from a group consisting of HDPE (high density polyethylene), LDPE (low density polyethylene), LLDPE (linear low density polyethylene), PE-HMW (high molecular weight polyethylene), PE-UHMW (ultra high molecular weight HDPE), ethylene copolymers, preferably (in each case independently of one another) ethylene-vinyl acetate copolymer (EVA), methacrylic acid ethyl ester (EMA), ethylene/acrylic acid copolymer (EAA) and ethylene-butyl acrylate copolymer (EBA) or mixtures thereof, isotactic polypropylene (iPP), syndiotactic polypropylene (sPP) and atactic polypropylene (aPP), polypropylene foam (EPP), unstretched polypropylene film (CPP), (unidirectional or bidirectional) stretched polypropylene films (OPP and BOPP) and a mixture thereof, or a combination of polypropylene with ethylene as comonomer, preferably polypropylene copolymer, preferably polypropylene random copolymer with ethylene as comonomer, or a polypropylene-ethylene block copolymer.

21. A plastic recyclate which comprises a packaging material as claimed in claim 16, in a proportion by weight selected from the group consisting of ≤25%, ≤70%, ≤75%, and ≤90%.

22. The plastic recyclate according to claim 21, wherein
the recyclate is a granulate, wherein the granulate preferably has an average particle size (d50 sieve analysis) in the range selected from the group consisting of ≤0.5 mm to ≤25 mm, ≤0.75 mm to ≤20 mm, ≤1 mm to ≤10 mm and ≤0.3 mm to ≤6 mm.

23. A method for producing a plastic recyclate as claimed in claim 21, comprising the steps
a) providing plastic waste comprising a packaging material according to as claimed in claim 21, in a proportion by weight selected from the group consisting of ≤25%, ≤70%, ≤75%, and ≤90%;
b) cleaning the plastic waste;
c) optionally shredding and/or mixing the plastic waste;
d) feeding the plastic waste into an extruder and producing an extrudate from the plastic waste; and
e) crushing the extrudate into granules.

24. The method according to claim 23, wherein
step b) is carried out before step d) and preferably steps a) to e) are carried out in the above-mentioned sequence.

25. A method for predicting the recyclability of a plastic-containing packaging material containing a printing ink and/or an adhesive, comprising the steps
provide a sample of the ink and/or adhesive;
performing a thermogravimetric analysis of the sample, wherein the thermogravimetric analysis includes at least one measurement of the mass changes in a temperature range of ≤30° C. to ≤320° C.;
set a critical temperature value in said temperature range;
determine the mass loss of the sample at the critical temperature; and
classify the recyclability of the ink and/or adhesive based on the mass loss of the sample at the critical temperature.

26. The method according to claim 25, wherein
the printing ink is dried before the thermogravimetric analysis is carried out, and wherein the drying is preferably carried out at a temperature selected from the group consisting of ≤20° C. and ≤100° C., ≤30° C. and ≤50° C., and 40° C.±3° C., and/or the drying is carried out over a period selected from the group consisting of between ≤2 days and ≤14 days, ≤3 days and ≤10 days, ≤4 days and ≤7 days, and 5 days±12 hours.

27. The method according to claim 25, wherein
the adhesive is dried and/or cured before the thermogravimetric analysis is carried out, wherein the drying and/or curing is preferably carried out at a temperature selected from the group consisting of ≤50° C. and ≤150° C., 80° C.-120° C., ≤90° C.-110° C., and/or over a period of 5 days±24 hours, wherein the isocyanate and/or solvent content determined after this period and, if a fixed limit value, which is set at ≤5% by weight, is exceeded, the drying and/or curing period at the above-mentioned temperature is extended by an additional drying and/or curing period selected from the group consisting of between ≤1 day and ≤5 days, ≤2 days and ≤4 days, and 3 days±12 hours.

28. The method according to claim 25, wherein
thermogravimetric analysis is carried out with a temperature increase selected from the group consisting of ≤10° C./min and ≤100° C./min, ≤20° C./min and ≤50° C./min, ≤25° C./min and ≤40° C./min, and at 30° C./min±3° C./min.

29. The method according to claim 25, wherein
a sample amount selected from the group consisting of less than 500 mg is used for the thermogravimetric analysis, ≤200 mg, ≤100 mg, ≤50 mg, ≤20 mg, and ≤10 mg, +5 mg.

30. The method according to claim 25, wherein
the thermogravimetric analysis is followed by an analysis of the resulting decomposition products, wherein the decomposition products are preferably analyzed by gas chromatography, the gas chromatographic analysis being carried out at a trigger temperature which corresponds to the melting temperature of the plastic during regranulation.

31. The packaging material according to claim 17, wherein
the printing ink and/or the adhesive is thermally stable does not form any gaseous decomposition products ≤15 percent by weight, and exhibits a weight loss in an amount selected from the group consisting of ≤10 percent by weight, ≤5 percent by weight, ≤3 percent by weight, and no gaseous decomposition products, when exposed to the temperature.

32. The packaging material according to claim 17, wherein the packaging material has a printing ink comprising a component selected from a group consisting of polyurethane, polyvinyl chloride, polyvinyl acetal, polyvinyl butyral, and a combination thereof.

33. The packaging material according to claim 17, wherein
the plastic is selected from a group consisting HDPE (high density polyethylene), LDPE (low density polyethylene), LLDPE (linear low density polyethylene), PE-HMW (high molecular weight polyethylene), PE-UHMW (ultra high molecular weight HDPE), ethylene copolymers, preferably (in each case independently of one another) ethylene-vinyl acetate copolymer (EVA), methacrylic acid ethyl ester (EMA), ethylene/acrylic acid copolymer (EAA) and ethylene-butyl acrylate copolymer (EBA) or mixtures thereof, isotactic polypropylene (iPP), syndiotactic polypropylene (sPP) and atactic polypropylene (aPP), polypropylene foam (EPP), unstretched polypropylene film (CPP), (unidirectional or bidirectional) stretched polypropylene films (OPP and BOPP) and a mixture thereof, or a combination of polypropylene with ethylene as comonomer, preferably polypropylene copolymer, preferably polypropylene random copolymer with ethylene as comonomer, or a polypropylene-ethylene block copolymer.

34. The packaging material according to claim 18, wherein the packaging material has a printing ink comprising a component selected from a group comprising polyurethane, polyvinyl chloride, polyvinyl acetal, polyvinyl butyral, and combinations thereof.

35. The packaging material according to claim 18, wherein
the plastic is selected from a group consisting of HDPE (high density polyethylene), LDPE (low density polyethylene), LLDPE (linear low density polyethylene), PE-HMW (high molecular weight polyethylene), PE-UHMW (ultra high molecular weight HDPE), ethylene copolymers, preferably (in each case independently of one another) ethylene-vinyl acetate copolymer (EVA), methacrylic acid ethyl ester (EMA), ethylene/acrylic acid copolymer (EAA) and ethylene-butyl acrylate copolymer (EBA) or mixtures thereof, isotactic polypropylene (iPP), syndiotactic polypropylene (sPP) and atactic polypropylene (aPP), polypropylene foam (EPP), unstretched polypropylene film (CPP), (unidirectional or bidirectional) stretched polypropylene films (OPP and BOPP) and a mixture thereof, or a combination of polypropylene with ethylene as comonomer, preferably polypropylene copolymer, preferably polypropylene random copolymer with ethylene as comonomer, or a polypropylene-ethylene block copolymer.
